(19) United States
(12) Patent Application Publication
(10) Pub. No.: US 2021/0250478 A1
(43) Pub. Date: Aug. 12, 2021

(54) CAMERA CLAMPING STRUCTURE AND PHOTOGRAPHING DEVICE

(71) Applicant: SZ DJI TECHNOLOGY CO., LTD., Shenzhen (CN)

(72) Inventors: Yin TANG, Shenzhen (CN); Xuegui FENG, Shenzhen (CN); Junqiang CHEN, Shenzhen (CN)

(21) Appl. No.: 17/241,048

(22) Filed: Apr. 26, 2021

Related U.S. Application Data
(63) Continuation of application No. PCT/CN2018/113180, filed on Oct. 31, 2018.

(51) Int. Cl. H04N 5/225; G02B 7/02; F16B 2/02

(52) U.S. Cl. CPC H04N 5/2254; F16B 2/02; G02B 7/021; G02B 7/026

(57) ABSTRACT

A camera clamping structure and a photographing device are provided. The camera clamping structure of the present disclosure includes a fixing frame. The fixing frame and a camera imaging module are arranged in parallel along a main optical axis of a camera lens, and the fixing frame encloses a cavity with openings at both ends. The cavity is configured to allow light to pass through the cavity to be received by the camera imaging module. One end of the fixing frame away from the camera imaging module is configured to clamp the lens of the camera. A cavity wall of the fixing frame is provided with an extinction structure.

### CROSS-REFERENCE TO RELATED APPLICATION

This application is a continuation of International Application No. PCT/CN2018/113180, filed on Oct. 31, 2018, the entire content of which is incorporated herein by reference.

### TECHNICAL FIELD

The present disclosure relates to the field of image capturing apparatus and, more particularly, to a camera clamping structure, and a photographing device.

### BACKGROUND

With continuous development of technologies, cameras, video cameras, and other photographing devices have been more and more widely used.

Currently, photographing devices generally include different components such as a main body, a lens, etc. The main body is provided with an image sensor and a clamp for connecting with the lens, and the lens is provided with an interface that matches the clamp, so that the lens can be connected to the clamp. External light can be converged onto the image sensor through the lens, to make the image sensor perform imaging.

However, part of structures in the clamp of the main body of the photographing device may reflect incident light from the lens to the image sensor, causing glare on an imaging screen.

### SUMMARY

The present disclosure provides a camera clamping structure and a photographing device to overcome glare phenomenon caused by incident light from a lens reflected to an image sensor.

In one aspect, the present disclosure provides a camera clamping structure, including a fixing frame. The fixing frame and a camera imaging module are arranged in parallel along a main optical axis of a lens of a camera. The fixing frame encloses a cavity with openings at two ends. The cavity is configured to allow light to pass through the cavity to be received by the camera imaging module. An end of the fixing frame away from the camera imaging module is configured to clamp the camera lens, and a cavity wall of the fixing frame is provided with an extinction structure.

In another aspect, the present disclosure provides a photographing device, including an image sensor, a lens, and the above-mentioned camera clamping structure. The image sensor and the lens are respectively located at opposite ends of the camera clamping structure, and a clamp of the lens is connected to the camera clamping structure.

In the camera clamping structure and the photographing device of the present disclosure, the camera clamping structure includes the fixing frame. The fixing frame and the camera imaging module are arranged in parallel along the main optical axis of the camera lens. The fixing frame encloses the cavity with the openings at the two ends. The cavity is configured to allow light to pass through the cavity to be received by the camera imaging module. The end of the fixing frame away from the camera imaging module is configured to clamp the camera lens, and the cavity wall of the fixing frame is provided with the extinction structure. By setting the extinction structure on the cavity wall of the fixing frame, incident light through the lens cannot be reflected to the camera imaging module, thereby effectively preventing glare on the imaging screen.

### BRIEF DESCRIPTION OF THE DRAWINGS

To illustrate technical solutions in the embodiments of the present disclosure or existing technologies more clearly, the accompanying drawings needed to be used in the embodiments or existing technologies will be briefly described below. It is obvious that the accompanying drawings in the following description are only some embodiments of the present disclosure. For those having ordinary skills in the art, other drawings can be obtained according to these accompanying drawings without inventive efforts.

FIG. 1 is a schematic structural diagram of a camera clamping structure according to one embodiment of the present disclosure;

FIG. 2 is a light path diagram after light entering a lens in existing technologies;

FIG. 3 is a light path diagram of light passing through a first side surface according to one embodiment of the present disclosure;

FIG. 4 is a light path diagram of light passing through another first side surface according to one embodiment of the present disclosure;

FIG. 5 is an exploded schematic diagram of a camera clamping structure according to one embodiment of the present disclosure;

FIG. 6 is a cross-sectional schematic diagram of a camera clamping structure according to one embodiment of the present disclosure;

FIG. 7 is a light path diagram formed when light irradiates a sharp ridge according to one embodiment of the present disclosure; and

FIG. 8 is a partial schematic diagram of assembling a buffer component and a second fixing component according to one embodiment of the present disclosure.

### DESCRIPTION OF REFERENCE SIGNS

1—Fixing frame; 2—Camera imaging module; 3—Extinction structure; 4—Extinction surface; 5—Main optical axis; 6—First fixing component; 7—Mounting component; 8—First side surface; 9—Second side surface; 10—Interface; 11—Front edge; 12—Rear edge; 13—Protective component; 14—Second fixing component; 15—Sharp ridge; 16—Inclined surface; 17—Buffer component; 18—Inner edge; 19—Clamping ring; 20—Extinction cloth; 21—Lens.

### DETAILED DESCRIPTION OF THE EMBODIMENTS

To illustrate the objectives, the technical solutions, and the advantages in the embodiments of the present disclosure more clearly, the technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. On the basis of the embodiments of the present disclosure, all other embodiments obtained by those having ordinary skills in the art without inventive efforts should fall within the protection scope of the present disclosure.

Cameras and other photographing devices generally include different components such as a main body and a lens. The main body is usually equipped with components such as a camera imaging module. After entering the main body of the photographing device from the lens, external light focus on an image sensor of the camera imaging module to perform imaging. To fix the lens on the main body, the photographing device includes a camera clamping structure. The camera clamping structure can be matched with a clamp of the lens to achieve relative fixation between the lens and the main body. The camera clamping structure is a hollow structure. After the external light enters the lens, it can pass through the camera clamping structure and irradiate the camera imaging module for imaging.

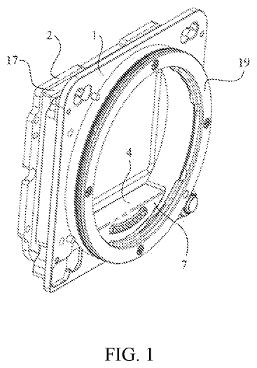

FIG. 1 is a camera clamping structure according to one embodiment of the present disclosure. As shown in FIG. 1, a camera clamping structure according to one embodiment of the present disclosure includes a fixing frame 1. The fixing frame 1 is arranged in parallel with a camera imaging module 2 along a main optical axis 5 of a lens 21 of a camera. The fixing frame 1 encloses a cavity with openings at two ends, and the cavity is configured to allow light to pass through the cavity to be received by the camera imaging module 2. One end of the fixing frame 1 away from the camera imaging module 2 is configured to clamp the lens 21 of the camera, and a cavity wall of the fixing frame 1 is provided with an extinction structure 3.

Specifically, the fixing frame 1 is a main body connection support structure of the camera clamping structure, and is configured to realize connection to the lens 21. Specifically, an extension line of the main optical axis 5 of the lens 21 can pass through the cavity of the fixing frame 1 and reach the camera imaging module 2, so that the lens 21, the fixing frame 1, and the camera imaging module 2 are arranged in parallel to ensure normal light transmission of the lens 21 and normal imaging of the camera imaging module 2. The fixing frame 1 is a cavity structure with openings at two ends. Incident light passes through the lens 21 and then irradiates the camera imaging module 2 through the cavity. One end of the openings at the two ends of the cavity is configured to connect to the camera imaging module 2, and another end is configured to clamp the lens 21 of the camera.

In a photographing device, when the incident light from the lens 21 passes through the camera clamping structure, it may be reflected to the camera imaging module 2 due to reflective effect of parts of the camera clamping structure, thereby causing glare on an imaging screen. To avoid the glare phenomenon and ensure imaging effect, the extinction structure 3 is provided on the cavity wall of the fixing frame 1 in this embodiment. The extinction structure 3 prevents the incident light from being reflected to the camera imaging module 2 when passing through the camera clamping structure, thereby eliminating the glare phenomenon.

In a possible implementation, the extinction structure 3 on the cavity wall of the fixing frame 1 may include an extinction surface 4. The extinction surface 4 and the main optical axis 5 of the lens 21 form an angle. A size of the angle between the extinction surface 4 and the main optical axis 5 of the lens 21 is configured to reflect light entering the cavity from the lens 21 to a spot outside a light incident area of the camera clamping structure. The extinction structure 3 configured to prevent the reflected light from entering the camera imaging module 2 can be the extinction surface 4 provided on the cavity wall of the fixing frame 1. The extinction surface 4 can reflect the incident light passing through the lens 21, and prevent the light from irradiating the camera imaging module 2, by reflecting the light to a spot outside the light incident area of the camera clamping structure.

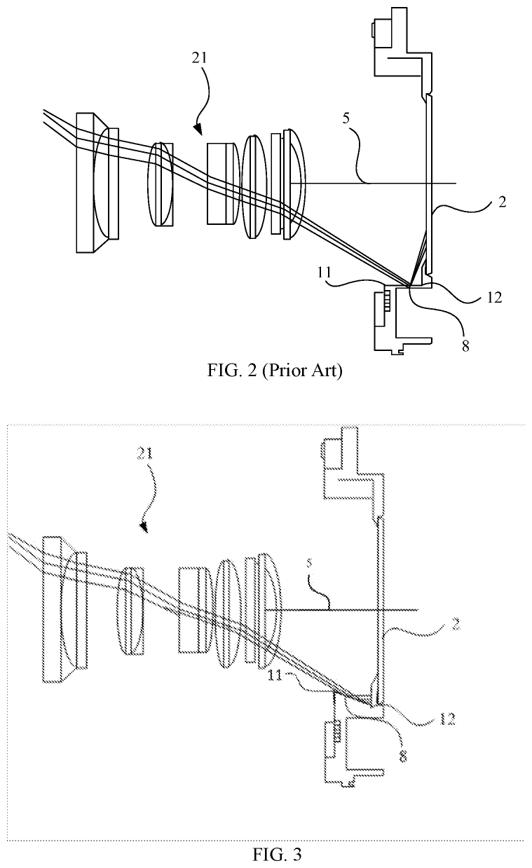

FIG. 2 is a light path diagram after light entering a lens in existing technologies. As shown in FIG. 2, when an inner wall of a cavity of a camera clamping structure is parallel to a main optical axis of a lens 21, incident light from an outermost lens edge of the lens 21 irradiates a cavity wall of a fixing frame after being refracted and converged by the lens. Reflected light formed after being reflected by the cavity wall will irradiate a camera imaging module, to cause the glare phenomenon. Therefore, the cavity of this embodiment is provided with the extinction surface, and there is the angle between the extinction surface and the main optical axis of the lens 21, so that the incident light irradiating the extinction surface through the lens 21 has a proper angle with the extinction surface. The incident light will not irradiate the camera imaging module after being reflected by the extinction surface, but will be reflected out of the light incident area of the camera clamping structure, without causing the glare phenomenon.

As shown in FIG. 1, the light incident area of the camera clamping structure is specifically an imaging area on the camera imaging module 2. The incident light irradiates, after being reflected by the extinction surface 4, a spot outside the light incident area of the camera clamping structure, that is, the reflected light does not enter the imaging area on the camera imaging module 2. Thus, the imaging area of the camera imaging module 2 will not have the glare phenomenon caused by irradiation of the light. In other words, due to the arrangement of the extinction surface 4 having the angle with the main optical axis 5, the light reflected by the extinction surface 4 will not irradiate the imaging area, thereby avoiding the glare phenomenon and ensuring image quality of the camera.

The fixing frame 1 may include a ring-shape first fixing component 6, and the first fixing component 6 extends along the main optical axis 5 of the lens 21. The first fixing component 6 extending along the direction of the main optical axis 5 is mainly configured for the connection between the camera clamping structure and the lens 21, and the lens 21 is fixedly connected to a camera clamp through the first fixing component 6. To allow the lens 21 to pass light normally, the fixing frame 1 of this embodiment has a ring structure, and the ring structure matches a cylindrical structure of the lens 21, so that a connecting component of the lens 21 and the camera clamping structure is connected correspondingly to the ring-shape first fixing component 6, and the incident light from the lens 21 can pass through a hollow part of the fixing frame 1 to irradiate the camera imaging module 2.

To achieve electrical connection with the lens 21, optionally, in the camera clamping structure, an inner wall of the first fixing component 6 is provided with a mounting component 7 protruding along the extension direction of the main optical axis 5 of the lens 21. The extinction surface 4 is a first side surface 8 of the mounting component 7 and the first side surface 8 faces the optical axis of the lens 21. In this way, the mounting component 7 may be provided with a structure such as contacts for the electrical connection with the lens 21. Specifically, the first fixing component 6 is disposed on a side of the fixing frame 1 facing the lens 21, and the incident light enters the camera clamping structure through the side of the fixing frame 1 provided with the first fixing component 6 after passing through the lens 21. Therefore, the extinction surface 4 is arranged on the side of the fixing frame 1 with the first fixing component 6 so that the light is reflected out of the light incident area when entering the camera clamping structure, that is, the light is reflected to a spot outside the imaging area of the camera imaging module 2.

The mounting component 7 has the first side surface 8 and the first side surface 8 faces the optical axis of the lens 21. The extinction surface 4 is the first side surface 8 of the mounting component 7, that is, the extinction surface 4 faces the optical axis of the lens 21. The light entering the camera clamping structure through the optical axis of the lens 21 and irradiating to the extinction surface 4 is reflected out of the imaging area of the camera imaging module 2 by the extinction surface 4, so that light entering the imaging area of the camera imaging module 2 only includes light incident from the lens 21 and does not include the reflected light, thereby eliminating the glare phenomenon.

The mounting component 7 may further include a second side surface 9 connected to the extinction surface 4. The second side surface 9 faces the lens 21, and an interface 10 for the electrical connection with the lens 21 is provided on this side surface of the mounting component 7. The mounting component 7 includes the first side surface 8 and the second side surface 9. The first side surface 8 is the aforementioned extinction surface 4, the second side surface 9 is connected to the first side surface 8, and the second side surface 9 faces the lens 21. The second side surface 9 is configured to be electrically connected to the lens 21 so that the incident light entering the camera clamping structure from the lens 21 can be imaged on the camera imaging module 2. Specifically, the interface 10 is provided on the second side surface 9, and the interface 10 is configured for the electrical connection between the camera clamping structure and the lens 21. Generally, the interface 10 may be in a form such as contacts or contact pins.

The first side surface 8 of the mounting component 7 has a front edge 11 facing the lens 21 and a rear edge 12 away from the lens 21. A distance between the front edge 11 and the main optical axis 5 of the lens 21 is different from a distance between the rear edge 12 and the main optical axis 5 of the lens 21. The first side surface 8 of the mounting component 7 is the extinction surface 4, which has two sides facing the lens 21 and away from the lens 21. The side facing the lens 21 is the front edge 11 of the first side surface 8, and the side away from the lens 21 is the rear edge 12 of the side surface 8. As described above, the extinction surface 4, which is the first side surface 8, forms an angle with the main optical axis 5.

FIG. 3 is a light path diagram of light passing through a first side surface according to one embodiment of the present disclosure. As shown in FIG. 3, the distance between the front edge 11 and the main optical axis 5 of the lens 21 is shorter than the distance between the rear edge 12 and the main optical axis 5 of the lens 21. In other words, the front edge 11 of the extinction surface 4 is closer to the main optical axis 5, and the rear edge 12 is further away from the main optical axis 5, which is equivalent to that the extinction surface 4 extends from the front edge 11 side to the main optical axis 5 and intersects the main optical axis 5. The angle between the extinction surface 4 and the main optical axis 5 is located on the side of the fixing frame 1 facing the lens 21, as shown in FIG. 3, so light incident on the extinction surface 4 through the edge of the lens 21 forms a small angle with the extinction surface 4, then, light reflected by the extinction surface 4 also forms a corresponding small angle with the extinction surface 4. The reflected light irradiates an edge of the fixing frame 1 in a direction almost parallel to the extinction surface 4, without being reflected to the imaging area of the camera imaging module 2.

Further, the angle between the first side surface 8 and the main optical axis 5 of the lens 21 may be greater than or equal to 40°. The first side surface 8, which is the extinction surface 4, extends from the front edge 11 side to the main optical axis 5, and the angle formed therewith is greater than or equal to 40°, which can ensure that incident light that irradiates the extinction surface 4 from the edge of the lens 21 and forms a largest angle with the extinction surface 4, after being reflected by the extinction surface 4, irradiates a spot outside the imaging area of the camera clamping structure. In this way, remaining incident light irradiates a place out of the imaging area after being reflected by the extinction surface 4. In addition, the angle between the extinction surface 4 and the main optical axis 5 is greater than or equal to 40°, which is only set for general photographing devices, while for other more special photographing devices, as long as it is ensured that all incident light that irradiates the extinction surface 4 can be reflected out of the imaging area by the extinction surface 4, the angle between the extinction surface 4 and the main optical axis 5 can also be limited to other ranges. When the angle between the extinction surface 4 and the main optical axis 5 of the lens 21 is set to be larger, it can also prevent light from directly irradiating the extinction surface 4, so the extinction surface 4 will not produce the reflected light, and will not create the glare phenomenon in the imaging area.

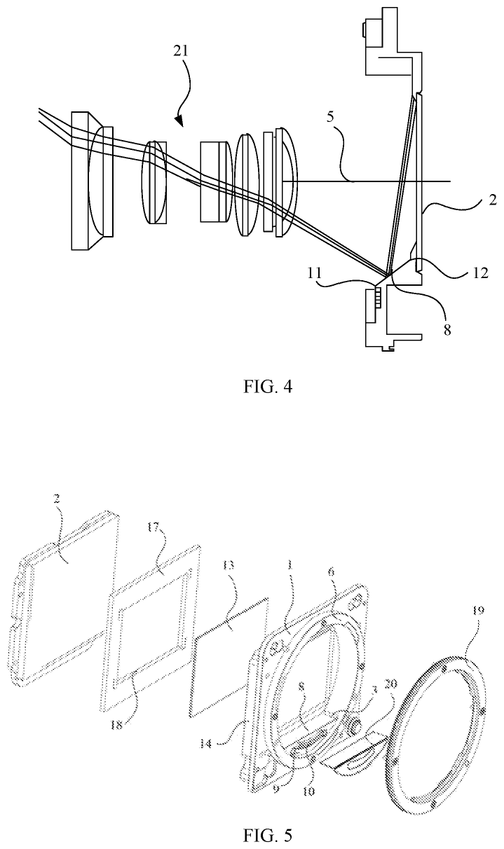

In addition to using the front edge 11 of the extinction surface 4 to be closer to the main optical axis 5, and the rear edge 12 to be further away from the main optical axis 5 to realize the extinction surface 4 to reflect light out of the imaging area, there can also be other ways to achieve the extinction surface 4 to reflect the light out of the imaging area to eliminate the glare phenomenon. For example, this embodiment also provides an implementation manner in which light can be reflected out of the imaging area through the extinction surface 4. FIG. 4 is a light path diagram of another first side surface according to one embodiment of the present disclosure. As shown in FIG. 4, the first side surface 8 has the front edge 11 facing the lens 21 and the rear edge 12 away from the lens 21. The distance between the front edge 11 and the main optical axis 5 of the lens 21 is greater than the distance between the rear edge 12 and the main optical axis 5 of the lens 21.

Specifically, as in the foregoing embodiment, the first side surface 8 is still used as the extinction surface 4. The extinction surface 4 includes two sides facing the lens 21 and away from the lens 21, that the side facing the lens 21 is the front edge 11 of the first side surface 8, and the side away from the lens 21 is the rear edge 12 of the first side surface 8. The extinction surface 4, which is the first side surface 8, have an angle with the main optical axis 5. A difference is that the distance between the front edge 11 and the main optical axis 5 of the lens 21 is greater, while the distance between the rear edge 12 and the main optical axis 5 is shorter. In other words, the front edge 11 is further away from the main optical axis 5 and the rear edge 12 is closer to the main optical axis 5. As shown in FIG. 4, the front edge 11 of the extinction surface 4 is further from the main optical axis 5, and the rear edge 12 is closer to the main optical axis 5. It can be considered that the extinction surface 4 extends from the rear edge 12 to the main optical axis 5 and intersects the main optical axis 5, and the angle between the extinction surface 4 and the main optical axis 5 is located on the side of the fixing frame 1 away from the lens 21, so that the light incident on the extinction surface 4 through the edge of the lens 21 forms a large angle with the extinction surface 4, so the light reflected by the extinction surface 4 also forms a corresponding large angle with the extinction surface 4. The reflected light irradiates in a direction almost parallel to a plane where the fixing frame 1 is located, to the edge of the fixing frame 1, or irradiates to an area outside the fixing frame 1, without being reflected to the imaging area of the camera imaging module 2.

Further, the angle between the first side surface 8 and a radial direction of the lens 21 is less than 90°. In this embodiment, the front edge 11 of the extinction surface 4 is further away from the main optical axis 5 and the rear edge 12 is closer to the main optical axis 5. The angle formed between the extinction surface 4 and the main optical axis 5 is located at the side of the fixing frame 1 away from the lens 21. The angle between the first side surface 8, which is the extinction surface 4, and the radial direction of the lens 21 is less than 90°. In other words, the angle between the extinction surface 4 and the main optical axis 5 is greater than 0°, which can ensure the incident light that irradiates the extinction surface 4 from the edge of the lens 21 and forms a smallest angle with the extinction surface 4, after being reflected by the extinction surface 4, irradiates outside the imaging area of the camera clamping structure. In this way, remaining incident light irradiates outside the imaging area after being reflected by the extinction surface 4. In one embodiment, the angle between the extinction surface 4 and the radial direction of the lens 21 may be less than or equal to 45°. In addition, the angle between the extinction surface 4 and the radial direction of the lens 21 being less than or equal to 45° does not constitute a complete limitation to this embodiment. As long as it is ensured that all incident light that irradiates the extinction surface 4 can be reflected by the extinction surface 4, to be outside the imaging area, the angle between the extinction surface 4 and the main optical axis 5 can also be limited to other ranges.

As mentioned above, one end of the fixing frame 1 of the camera clamping structure of this embodiment is connected to the lens 21, and the other end is provided with the camera imaging module 2. The imaging area of the camera imaging module 2 is configured to make the incident light passing through the lens 21 to form images. If the camera imaging module 2 directly contacts the fixing frame 1, the camera imaging module 2 may be worn out, which may result in deterioration of the images formed in the imaging area, and may even damage the camera imaging module 2. Therefore, the camera clamping structure of this embodiment further includes a transparent protective component 13, which is arranged on the fixing frame 1.

FIG. 5 is an exploded schematic diagram of a camera clamping structure according to one embodiment of the present disclosure. As shown in FIG. 5, the camera imaging module 2 is not directly connected to the fixing frame 1. A protective component 13 is also provided between the camera imaging module 2 and the fixing frame 1. The protective component 13 is configured to protect the camera imaging module 2 from being scratched or damaged by the fixing frame 1. The protective component 13 can be fixed to the side of the fixing frame 1 that is connected to the camera imaging module 2, and then the camera imaging module 2 and the fixing frame 1 are connected on the basis of the protective component 13. The protective component 13 is a transparent protective component 13 so that the incident light can pass through the protective component 13 to irradiate the imaging area of the camera imaging module 2.

Furthermore, to make the protective component 13 not only have good protective effect, but also good light transmission effect, the protective component 13 may be a transparent glass plate, or a sapphire glass plate with higher hardness, etc.

The first fixing component 6 of the fixing frame 1 is configured to realize the connection between the fixing frame 1 and the lens 21. To realize installation of the protective component 13 and other components, the fixing frame 1 further includes a second fixing component 14, which is located at one end of the first fixing component 6 away from the lens 21. The second fixing component 14 protrudes inwardly along the radial direction of the lens 21 and abuts the protective component 13. The second fixing component 14 is provided with the extinction surface 4.

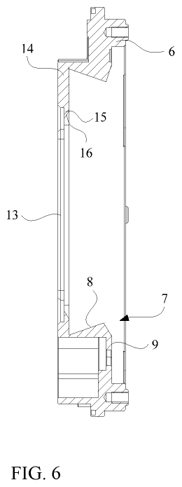

FIG. 6 is a cross-sectional schematic diagram of a camera clamping structure according to one embodiment of the present disclosure. As shown in FIG. 6, the fixing frame 1 is a cavity with openings at two ends, the first fixing component 6 is located on one opening at one end of the cavity, and the second fixing component 14 is located on one opening at the other end of the cavity. The second fixing component 14 protrudes inwardly with respect to the first fixing component 6, in the radial direction of the lens 21, that is, along the radial direction of the ring-shape first fixing component 6 of the fixing frame 1, and the protective component 13 is arranged on the second fixing component 14 that protrudes inwardly.

Specifically, as shown in FIG. 6, a shape of a side wall of the protective component 13 matches a shape of an inner wall of the second fixing component 14, so that the protective component 13 is clamped on the second fixing component 14. The camera imaging module 2 is connected to the fixing frame 1 through the protective component 13. Generally, card slots matching an outer edge of a glass plate can be provided on the second fixing component 14, and the protective component 13 such as the glass plate can be put into the card slots to realize connection to the second fixing component 14. Structures such as screw holes or pin holes are provided at an edge of a non-imaging area of the camera imaging module 2, and structures such as screw holes or pin holes are also provided at corresponding positions of the fixing frame 1. Through the screw holes or the pin holes on the camera imaging module 2 and the fixing frame 1, the camera imaging module 2 and the fixing frame 1 are connected into a whole, to further fix a position of the protective component 13 between the camera imaging module 2 and the fixing frame 1.

In addition, the extinction surface 4 is provided on the second fixing component 14. Like the first fixing component 6, after the incident light enters the second fixing component 14 through the lens 21, part of structures on the second fixing component 14 may also reflect the incident light, and the reflected light may also irradiate the imaging area of the camera imaging module 2 to further cause the glare phenomenon on the imaging screen. Therefore, the extinction surface 4 is provided on the second fixing component 14 so that the light irradiated to the second fixing component 14 is reflected out of the imaging area through the extinction surface 4 to avoid the glare phenomenon.

Specifically, as shown in FIG. 6, a side of the second fixing component 14 protruding toward the main optical axis 5 of the lens 21 has a sharp ridge 15, and a side of the sharp ridge 15 facing the lens 21 forms an inclined surface 16. An angle between the inclined surface 16 and the radial direction of the lens 21 is greater than 135° to form the extinction surface 4. The second fixing component 14 is mainly configured for clamping connection between the protective component 13 and the fixing frame 1, and the second fixing component 14 includes the inner wall that matches the shape of the outer wall of the protective component 13, and the inwardly protruding sharp ridge 15 on the inner wall. The protective component 13 abuts on one side surface of the sharp ridge 15. The side surface of the sharp ridge 15 and a side surface of the protective component 13 are connected to each other. The sharp ridge 15 is configured to fix the protective component 13 in a relative position of the fixing frame 1, and can prevent the protective component 13 from moving left and right on the fixing frame 1.

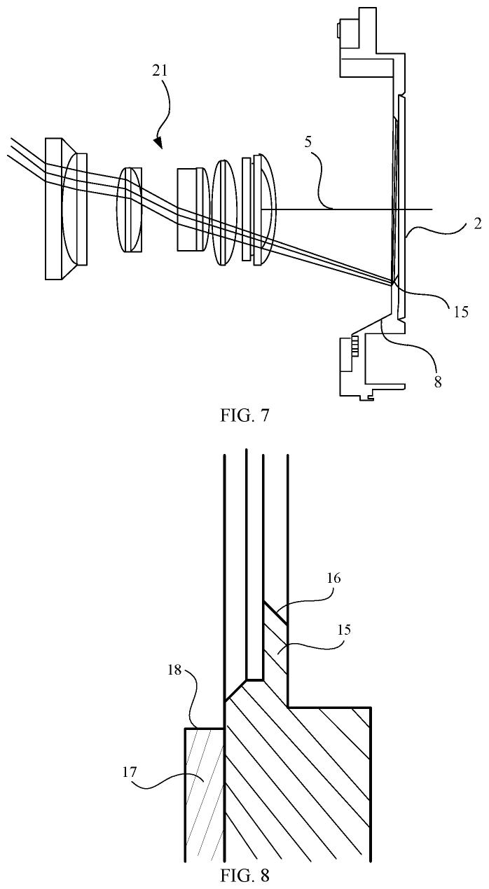

In addition, as shown in FIG. 6, the side of the sharp ridge 15 facing the lens 21 is the inclined surface 16. Setting this side of the sharp ridge 15 as the inclined surface 16 can prevent the sharp ridge 15 from reflecting light to the imaging area of the camera imaging module 2, when the light irradiates the sharp ridge 15 of the second fixing component 14. Specifically, FIG. 7 is a light path diagram formed when light irradiates a sharp ridge according to one embodiment of the present disclosure. As shown in FIG. 7, when light irradiates the sharp ridge 15 of the second fixing component 14 through the lens 21, the inclined surface 16 on the sharp ridge 15 can reflect the light to the non-imaging area of the camera imaging module 2 through the inclined surface 16, or to the edge of the second fixing component 14, or to other areas outside the second fixing component 14, without reflecting the light to the imaging area of the camera imaging module 2.

Further, the angle between the inclined surface 16 and the radial direction of the lens 21 may be greater than 135°, that is, the angle between the inclined surface 16 and a bottom surface of the protective component 13 as shown in FIG. 8 is greater than 135°, and the inclined surface 16 may be used as the extinction surface 4, to make the light reflected by the inclined surface 16 to irradiate an area outside the imaging area of the camera imaging module 2. The larger the angle between the inclined surface 16 and the radial direction of the lens 21 is set, the smaller an area of diffuse reflection, the weaker the light, and the better the anti-glare effect. Of course, as long as it is ensured that all incident light that irradiates the inclined surface 16 can be reflected out of the imaging area by the inclined surface 16, the angle between the inclined surface 16 and the radial direction of the lens 21 can also be limited to other ranges.

As shown in FIG. 5, to further ensure the imaging quality of the camera imaging module 2, the camera clamping structure of this embodiment further includes a buffer component 17. The buffer component 17 is located between the fixing frame 1 and the camera imaging module 2. The buffer component 17 is a hollow frame type, and the protective component 13 is sandwiched between the buffer component 17 and the second fixing component 14. The buffer component 17 is a hollow frame structure, and the buffer component 17 is disposed between the camera imaging module 2 and the fixing frame 1 to further improve the imaging quality of the camera imaging module 2. Specifically, when the camera clamping structure is assembled, the protective component 13 is first installed into the fixing frame 1 of the fixing frame 1, then the buffer component 17 is fixed on an outer surface of the second fixing component 14 facing the camera imaging module 2, and finally, the camera imaging module 2 and the fixing frame 1 are fixedly connected through the buffer component 17.

In addition, since the buffer component 17 is the hollow frame structure, if light irradiates to an inner edge 18 of the frame structure of the buffer component 17 through the second fixing component 14, the inner edge 18 of the buffer component 17, as a reflective surface, may also reflect the light to the imaging area of the camera imaging module 2. FIG. 8 is a partial schematic diagram of assembling a buffer component and a second fixing component according to one embodiment of the present disclosure. As shown in FIG. 8, to prevent the inner edge 18 of the buffer component 17 from reflecting incident light to the imaging area, a distance in the radial direction of the lens 21 between the inner edge 18 of the buffer component 17 and the sharp ridge 15 is greater than or equal to 0.8 mm to form the extinction surface 4. A distance in the radial direction of the lens 21 between the inner edge 18 of the buffer component 17 and the imaging area on the camera imaging module 2 is also greater than or equal to a specific value. It is ensured that the incident light is not reflected by the inner edge 18 of the buffer component 17 to the imaging area on the camera imaging module 2, that is, it is ensured that the distance in the radial direction of the lens 21 between the inner edge 18 of the buffer component 17 and the sharp ridge 15 of the second fixing component 14 is greater than or equal to a preset threshold, or it is sufficient to ensure that the distance in the radial direction of the lens 21 between the inner edge 18 of the buffer component 17 and the imaging area on the camera imaging module 2 is also greater than or equal to a specific value.

Specifically, the distance in the radial direction of the lens 21 between the inner edge 18 of the buffer component 17 and the sharp ridge 15 of the second fixing component 14 is greater than or equal to 0.8 mm. The distance in the radial direction of the lens 21 between the inner edge 18 of the buffer component 17 and the imaging area on the camera imaging module 2 is also greater than or equal to 1.1 mm.

The inner edge 18 of the buffer component 17 is located on an outer side of the sharp ridge 15 along the radial direction of the lens 21 to prevent the light from irradiating to the inner edge 18 of the buffer component 17 along the sharp ridge 15, thereby preventing the inner edge 18 from reflecting the light to the imaging area. Further, since the side of the sharp ridge 15 facing the lens 21 is the inclined surface 16, therefore, a certain distance is set between the inner edge 18 of the buffer component 17 and the sharp ridge 15 in this embodiment, and the specific distance is related to a slope of the inclined surface 16. The distance is set to prevent the light entering the camera imaging module 2 along the inclined surface 16 of the sharp ridge 15 from irradiating the inner edge 18 of the buffer component 17, so as to prevent the inner edge 18 from reflecting the light to the imaging area. A minimum distance between the inner edge 18 and the sharp ridge 15 should prevent the light passing through the second fixing component 14 from irradiating the inner edge 18 of the buffer component 17.

In addition, a projection of the inner edge 18 of the buffer component 17 in the direction along the main optical axis 5 of the lens 21 is located outside a photosensitive surface of the camera imaging module 2. As shown in FIG. 5, the buffer component 17 is arranged adjacent to the camera imaging module 2, and the projection of the inner edge 18 of the buffer component 17 in the direction of the main optical axis 5 is located outside the photosensitive surface of the camera imaging module 2. In other words, the photosensitive surface of the camera imaging module 2 can be completely exposed inside the hollow frame of the buffer component 17, and the buffer component 17 does not block the photosensitive surface. The incident light that irradiates from the lens 21 to the camera imaging module 2 can be completely absorbed by the photosensitive surface, to ensure the imaging quality of the camera imaging module 2.

Further, the buffer component 17 may be waterproof foam. The waterproof foam is arranged between the camera imaging module 2 and the fixing frame 1 as the buffer component 17, which can prevent water from entering the camera imaging module 2 through the fixing frame 1, and has good waterproof effect, thereby ensuring the imaging quality of the camera imaging module 2.

Except for setting the first side surface 8 of the first fixing component 6 as the extinction surface 4, using the extinction surface 4 as the extinction structure 3 on the cavity wall of the fixing frame 1, and reflecting the light that irradiates the extinction surface 4 out of the imaging area of the camera imaging module 2 by the extinction surface 4, the extinction structure 3 may also be other structures that can eliminate the glare phenomenon. Specifically, the extinction structure 3 provided on the cavity wall of the fixing frame 1 may be an extinction cloth 20. The extinction cloth 20 absorbs the incident light irradiated to an extinction component, so that no reflected light that irradiates the imaging area is generated, thereby eliminating the glare phenomenon.

Specifically, the fixing frame 1 includes the ring-shape first fixing component 6, and the first fixing component 6 extends along the main optical axis 5 of the lens 21. As shown in FIG. 5, the fixing frame 1 includes the ring-shape first fixing component 6, and the first fixing component 6 extends along the main optical axis 5 of the lens 21. The first fixing component 6 extending along the direction of the main optical axis 5 is mainly configured for the connection between the camera clamping structure and the lens 21, and the lens 21 is fixedly connected to the camera clamp through the first fixing component 6. To match the cylindrical structure of the lens 21, the fixing frame 1 of this embodiment has the ring structure. The ring structure matches the cylindrical structure of the lens 21, so that the connecting component between the lens 21 and the camera clamping structure is correspondingly connected to the ring-shape first fixing component 6.

Further, the inner wall of the first fixing component 6 is provided with the mounting component 7 protruding along the extension direction of the main optical axis 5 of the lens 21. The extinction surface 4 is the first side surface 8 of the mounting component 7. The first side surface 8 is parallel to the main optical axis 5 of the lens 21, and the first side surface 8 is covered with the extinction cloth 20. The mounting component 7 is provided on the inner wall of the first fixing component 6, the mounting component 7 protrudes along the extension direction of the main optical axis 5, and the extinction surface 4 is provided on the mounting component 7. The mounting component 7 has the first side surface 8, and the first side surface 8 faces the optical axis of the lens 21. The extinction surface 4 is the first side surface 8 of the mounting component 7. A difference from the aforementioned extinction surface 4 of the first side surface 8 that reflects the incident light out of the imaging area of the camera imaging module 2 is that the first side surface 8 as the extinction surface 4 covered with the extinction cloth 20 is configured here. The light irradiating on the extinction surface 4 is absorbed by the extinction cloth 20, so as to eliminate the glare phenomenon. Compared with the aforementioned extinction surface 4, the extinction cloth 20 does not reflect light out of the imaging area, but absorbs light so that no reflected light is generated, thereby eliminating the glare phenomenon on the imaging area.

As shown in FIG. 5, the fixing frame 1 of the camera clamping structure is also provided with components for connecting with the lens 21. Specifically, the camera clamping structure further includes a clamping ring 19 for clamping the clamp of the lens 21, and the clamping ring 19 is located on one end surface of the cavity. The camera clamping structure and the lens 21 are clamp-connected through the clamp provided on the lens 21. The clamping ring 19 is correspondingly provided on the fixing frame 1 of the camera clamping structure, and the clamping ring 19 and the clamp are clamp-connected to realize the connection between the fixing frame 1 and the lens 21. The clamping ring 19 is assembled on one end surface of the cavity formed by the fixing frame 1, specifically the end surface facing the lens 21.

In this embodiment, the camera clamping structure includes the fixing frame. The fixing frame and the camera imaging module are arranged in parallel along the main optical axis of the camera lens. The fixing frame encloses the cavity with two openings at two ends. The cavity is configured to allow light to pass through the cavity to be received by the imaging module of the camera. The end of the fixing frame away from the imaging module of the camera is configured for clamping the camera lens, and the cavity wall of the fixing frame is provided with the extinction structure. In this way, by providing the extinction structure on the cavity wall of the fixing frame, the light incident through the lens will not be reflected to the camera imaging module, effectively avoiding the glare phenomenon.

In the camera clamping structure, the extinction structure 3 provided on the cavity wall of the fixing frame 1 is not only the extinction surface 4 having an angle with the main optical axis 5 of the lens 21, and controlling the reflection angle of the extinction surface 4 to avoid glare, but also configuring the cavity wall of the fixing frame 1 as a surface with low light reflectivity, so as to prevent the light from the lens 21 from being reflected by the cavity wall to the camera imaging module 2 after being irradiated on the cavity wall. Specifically, the extinction structure 3 includes an extinction layer located on the cavity wall of the fixing frame 1. In addition, the structures, functions, and working principles of other components of the camera clamping structure are similar to those in the foregoing one embodiment, and will not be repeated here.

Specifically, a surface of the extinction layer can usually produce diffuse reflection or can be the surface with low light reflectivity. When the light from the lens 21 is irradiated on the extinction layer, it will be absorbed by the extinction layer or diffuse reflection is caused. Therefore, light intensity of the light reflected to the camera imaging module 2 is reduced, and the glare phenomenon caused by the light being directly reflected to the camera imaging module 2 is avoided. Specifically, the surface of the extinction layer may be an extinction surface, and diffuse reflection effect of the extinction surface is configured to achieve light absorption; or the extinction layer may also be made of a material that can absorb light.

When the light from the lens 21 irradiates the cavity wall of the fixing frame 1, because different cavity walls of the fixing frame 1 will be located in different directions facing the lens 21 or away from the lens 21, the cavity wall facing away from the lens 21 will not form the glare, so the extinction layer can only cover a portion of the cavity wall of the fixing frame 1 that may cause the glare, while other cavity walls that do not cause the glare need not be covered with the extinction layer.

In addition, it can be understood that the extinction layer can also cover all the cavity wall surfaces of the fixing frame 1, so that the camera clamping structure has better extinction effect.

As one of the optional methods, the extinction layer is an extinction paint coated on the cavity wall. In this way, the extinction paint can be covered on the cavity wall surfaces of the fixing frame 1 by spraying, etc., the extinction layer is formed, so as to adapt to different cavity wall shapes, and the extinction layer covers more uniformly and comprehensively on the cavity wall. At the same time, the extinction layer also does not occupy additional cavity wall space, which facilitates placement of other components of the camera clamping structure.

Specifically, the extinction paint can be of many different types and extinction principles. For example, the extinction paint can form tiny bumps on a surface of a coating film, which diffusely reflect incident light, thereby absorbing light and reducing surface gloss. Specifically, the extinction paint may be an extinction material commonly used by those skilled in the art such as ultrafine synthetic silica, micronized wax, etc., which is not limited here.

Optionally, similar to the foregoing one embodiment, the fixing frame 1 includes the ring-shape first fixing component 6 extending along the main optical axis 5 of the lens 21, thus forming a structure similar to a sleeve. A surface of the first fixing component 6, that is, an inner wall of the sleeve may be provided with the extinction layer.

Specifically, to achieve the electrical connection with the lens 21, similar to the foregoing one embodiment, the inner wall of the first fixing component 6 may also be provided with the mounting component 7 protruding along the extension direction of the main optical axis 5 of the lens 21, and the mounting component 7 has the first side surface 8 facing the main optical axis 5 of the lens 21 and the second side surface 9 facing the lens 21. The second side surface 9 is provided with the interface 10 for the electrical connection with the lens 21. Since the first side surface 8 is generally parallel to the extension direction of the main optical axis 5 of the lens 21, when the external light is irradiated on the first side surface 8, it may be reflected to the camera imaging module 2, causing the glare phenomenon. At this time, the extinction layer can cover the first side surface 8. At this time, after the external light is irradiated on the first side surface 8, it will be absorbed by the extinction layer, thereby eliminating the glare phenomenon caused by the reflection of the first side surface 8.

In addition, as an optional manner, the extinction layer may also cover the second side surface 9. In this way, the first side surface 8 and the second side surface 9 of the mounting component 7 are both covered by the extinction layer, and anti-glare effect is better.

It should be noted that when the first side surface 8 is covered with the extinction layer to avoid the glare caused by the first side surface 8, the angle of the first side surface 8 can be parallel to the extension direction of the main optical axis 5 of the lens 21, or as described in the foregoing one embodiment, it can be a certain angle with the extension direction of the main optical axis 5 of the lens 21 to form the extinction surface 4, which can form better anti-glare effect.

In addition, when the transparent protective component 13 is provided in the camera clamping structure, to fix the protective component 13, optionally, the fixing frame 1 may further include the second fixing component 14. The second fixing component 14 is located at one end of the first fixing component 6 away from the lens 21, and the second fixing component 14 protrudes inwardly along the radial direction of the lens 21 and is configured to abut the protective component 13. At this time, to avoid the glare phenomenon on the side of the second fixing component 14 facing the lens 21, the extinction layer may also be provided on the side of the second fixing component 14 facing the lens 21. In this way, when the external light incident on the lens 21 irradiates the side of the second fixing component 14 facing the lens 21, it will be absorbed by the extinction layer and cannot be reflected to the camera imaging module 2 again, and the glare phenomenon is avoided.

In this embodiment, the camera clamping structure includes the fixing frame. The fixing frame and the camera imaging module are arranged in parallel along the main optical axis of the camera lens. The fixing frame encloses the cavity with openings at two ends. The cavity is configured to allow light to pass through the cavity to be received by the imaging module of the camera. The end of the fixing frame away from the camera imaging module is configured for clamping the camera lens, and the cavity wall of the fixing frame is provided with the extinction structure. By setting the extinction structure on the cavity wall of the fixing frame, the light incident through the lens will not be reflected to the camera imaging module, effectively avoiding the glare phenomenon.

This embodiment also provides a photographing device, including an image sensor, a lens 21, and the camera clamping structure described in the foregoing one embodiment or 2. The camera clamping structure can be relatively fixed to a main structure of the photographing device and is configured to realize positioning of the lens 21 and connection between the lens 21 and the main structure of the photographing device. The image sensor is a part of a camera imaging module, and the image sensor and the lens 21 are located at opposite ends of the camera clamping structure. A clamp of the lens 21 and the camera clamping structure are connected to each other. The camera clamping structure includes the fixing frame 1, and the cavity wall of the cavity formed by the fixing frame 1 is provided with the extinction structure 3, which can prevent the external light from being reflected by the cavity wall in the camera clamping structure and irradiating the image sensor to cause the glare phenomenon, which affects photographing quality. The structure, function and working principle of the camera clamping structure have been described in detail in the foregoing embodiments, and will not be repeated here.

Specifically, the photographing device can be a camera, a video camera, a sports camera, and other different types. In addition, the photographing device may have a detachable lens 21, and the lens 21 is connected to the main body of the photographing device through the camera clamping structure, so as to realize imaging of external scenes on the image sensor.

In this embodiment, the photographing device includes the image sensor, the lens, and the camera clamping structure. The camera clamping structure includes the fixing frame. The fixing frame and the camera imaging module are arranged in parallel along the main optical axis of the camera lens, and the fixing frame encloses the cavity with openings at two ends. The cavity is configured to allow light to pass through the cavity to be received by the camera imaging module. The end of the fixing frame away from the camera imaging module is configured to clamp the camera lens, and the cavity wall of the fixing frame is provided with the extinction structure. By setting the extinction structure on the cavity wall of the fixing frame, the light incident through the lens will not be reflected to the camera imaging module, effectively avoiding the glare phenomenon.

Finally, it should be noted that the above embodiments are only used to illustrate the technical solutions of the present disclosure, but not to limit it. Although the present disclosure has been described in detail with reference to the foregoing embodiments, those of ordinary skill in the art should understand: it is still possible to modify the technical solutions described in the foregoing embodiments, or equivalently replace some or all of the technical features; and these modifications or replacements do not make essence of the corresponding technical solutions deviate from the scope of the technical solutions of the embodiments of the present disclosure.

What is claimed is:

1. A camera clamping structure, comprising a fixing frame, wherein the fixing frame and a camera imaging module are arranged in parallel along a main optical axis of a lens of a camera, the fixing frame encloses a cavity with openings at two ends, the cavity is configured to allow light to pass through the cavity to be received by the camera imaging module, one end of the fixing frame away from the camera imaging module is configured to clamp the lens, and a cavity wall of the fixing frame is provided with an extinction structure.

2. The camera clamping structure according to claim 1, wherein the extinction structure on the cavity wall of the fixing frame includes an extinction surface, and a size of an angle between the extinction surface and the main optical axis of the lens is configured to reflect the light entering the cavity from the lens out of a light incident area of the camera clamping structure.

3. The camera clamping structure according to claim 2, wherein the light incident area of the camera clamping structure is an imaging area on the camera imaging module.

4. The camera clamping structure according to claim 1, wherein the fixing frame includes a ring-shape first fixing component, and the first fixing component extends along a direction of the main optical axis of the lens.

5. The camera clamping structure according to claim 4, wherein an inner wall of the first fixing component is provided with a mounting component protruding along an extension direction of the main optical axis of the lens, the extinction surface is a first side surface of the mounting component, and the first side surface faces the optical axis of the lens.

6. The camera clamping structure according to claim 5, wherein the mounting component further includes a second side surface connected to the extinction surface, the second side surface faces the lens, and the second side surface of the mounting component is provided with an interface configured to be electrically connected to the lens.

7. The camera clamping structure according to claim 5, wherein the first side surface has a front edge facing the lens and a rear edge away from the lens, and a distance between the front edge and the main optical axis of the lens is shorter than a distance between the rear edge and the main optical axis of the lens.

8. The camera clamping structure according to claim 5, wherein the first side surface has a front edge facing the lens and a rear edge away from the lens, and a distance between the front edge and the main optical axis of the lens is greater than a distance between the rear edge and the main optical axis of the lens.

9. The camera clamping structure according to claim 1, wherein the fixing frame further includes a second fixing component, the second fixing component is located at one end of the first fixing component away from the lens, and the second fixing component protrudes inwardly along a radial direction of the lens and is configured to abut the protective component; and the second fixing component is provided with the extinction surface.

10. The camera clamping structure according to claim 9, wherein a side of the second fixing component protruding toward the main optical axis of the lens has a sharp ridge, a side of the sharp ridge facing the lens forms an inclined surface, and an angle between the inclined surface and the radial direction of the lens is greater than 135° to form the extinction surface.

11. The camera clamping structure according to claim 10, wherein further comprising a buffer component located between the fixing frame and the camera imaging module, wherein the buffer component has a hollow frame shape, and the protective component is sandwiched between the buffer component and the second fixing component.

12. The camera clamping structure according to claim 1, wherein the extinction structure provided on the cavity wall of the fixing frame is an extinction cloth.

13. The camera clamping structure according to claim 12, wherein: the fixing frame includes a ring-shape first fixing component, the first fixing component extends along a direction of the main optical axis of the lens, an inner wall of the first fixing component is provided with a mounting component protruding along the extension direction of the main optical axis of the lens, the extinction surface is a first side surface of the mounting component, the first side surface is parallel to the main optical axis of the lens, and the first side surface is covered with the extinction cloth.

14. The camera clamping structure according to claim 11, wherein a projection of the inner edge of the buffer component in the direction along the main optical axis of the lens is located outside of a photosensitive area of the camera imaging module.

15. The camera clamping structure according to claim 1, wherein further comprising a clamping ring configured to connect to a clamp of the lens, the clamping ring being located on an end surface of the cavity.

16. The camera clamping structure according to claim 1, wherein the extinction structure includes an extinction layer on the cavity wall of the fixing frame, and the extinction layer covers at least a part of the cavity wall of the fixing frame.

17. The camera clamping structure according to claim 16, wherein the fixing frame includes a ring-shape first fixing component, the first fixing component extends along a direction of the main optical axis of the lens, and the extinction layer is provided on a surface of the first fixing component.

18. The camera clamping structure according to claim 17, wherein an inner wall of the first fixing component is provided with a mounting component protruding along the extension direction of the main optical axis of the lens, the mounting component has a first side surface facing the main optical axis of the lens and a second side surface facing the lens, the second side surface is provided with an interface for electrical connection with the lens, the extinction layer covers the first side surface and the second surface.

19. The camera clamping structure according to claim 17, wherein the fixing frame further includes a second fixing component, and the second fixing component is located at one end of the first fixing component away from the lens, and the second fixing component protrudes inwardly along the radial direction of the lens and is configured to abut the protective component; and a side of the second fixing component facing the lens is provided with the extinction layer.

20. A photographing device, comprising an image sensor, a lens, and a camera clamping structure, wherein the image sensor and the lens are respectively located at opposite ends of the camera clamping structure, a clamp of the lens is connected to the camera clamping structure; and
the camera clamping structure includes a fixing frame, the fixing frame and the camera imaging module are arranged in parallel along a direction of a main optical axis of the lens, the fixing frame encloses a cavity with openings at two ends, the cavity is configured to allow light to pass through the cavity to be received by the camera imaging module, one end of the fixing frame away from the camera imaging module is configured to clamp the lens, and a cavity wall of the fixing frame is provided with an extinction structure.
